(19) United States
(12) Patent Application Publication
(10) Pub. No.: US 2002/0012820 A1
(43) Pub. Date: Jan. 31, 2002

(54) IMPROVED STRUCTURE OF SYNTHETIC LEATHER

(76) Inventor: KUO-HO KUO, TAIPEI (TW)

Correspondence Address: DOUGHERTY & TROXELL, 5202 LEESBURG PIKE, SUITE 1404, FALLS CHURCH, VA, 22041-3401, US

(21) Appl. No.: 09/222,887

(22) Filed: Dec. 30, 1998

(51) Int. Cl. B32B 5/02; B32B 3/00; B32B 9/00

(52) U.S. Cl. 428/904

(57) ABSTRACT

This invention discloses an improved structure of a synthetic leather. The synthetic leather of the present invention includes a piece of backing cloth with all-direction stretchability located at one end of the synthetic leather, a surface skin located at another end of the synthetic leather, and an intermediate layer fixed between the backing cloth and the surface skin for providing thickness of the synthetic leather. Thereby the synthetic leather of the present invention can concurrently have characteristics of high thickness, high softness and a fine-break surface.

### BACKGROUND OF THE INVENTION

1. Field of the Invention

The present invention relates to a structure of a synthetic leather, and more particularly to an improved structure of a synthetic leather having characteristics of high thickness, high softness and a fine-break surface.

2. Description of the Prior Art

In the early development of human history, the leather products of shoes or clothes were manufactured by genuine leathers of hunted animals. Those leather products were by-product of food. Because of the limitation of natural sources, the supply of genuine leathers was unstable and limited. Also, the cost of genuine leathers was expensive. Until the development of petrochemical industry, the technology of producing synthetic leathers is gradually mature. The supply of synthetic leathers is stable, and the cost of synthetic leathers is cheaper. Furthermore, a variety of synthetic leathers can be produced according to the requests of different products.

In general, a synthetic leather has two basic elements. One is an upper structure located at one end of the synthetic leather for providing thickness and a genuine leather-like appearance and touch. Another is a piece of backing cloth located at another end or in the middle of the synthetic leather for providing physical properties. The upper structure and the backing cloth are fixed together to form a multilayer synthetic leather. In order to produce a synthetic leather with an improved quality, the thickness, softness, and surface break (crumple from bending) of synthetic leathers are important characteristics for new developed synthetic leathers.

Generally, the synthetic leather products with high thickness and high softness have wide commercial use as a substitute for genuine leathers in the production of various articles such as shoes, hiking boots, wearing apparel, baseball gloves, and accessories. However, in the conventional products, synthetic leathers cannot concurrently have the characteristics of high thickness, high softness and a fine-break surface. Now referring to FIG. 1, a cross-section view of a conventional synthetic leather with a poor-break surface, a synthetic leather has a piece of backing cloth 1 and an upper structure 2. When the surface of synthetic leather is bended concave, the poor break (or rough break) is formed by compressing in the top surface of the upper structure 2. The degree of break roughness will increase with the increasing thickness. In the prior art, the hardness of the upper structure 2 is increased for alleviating the break roughness, which will effect the touch and feeling property of the leather. Therefore, the conventional synthetic leather products cannot concurrently have the characteristics of high thickness, high softness and a fine-break surface.

### SUMMARY OF THE INVENTION

It is an object of the present invention to provide an improved structure of a synthetic leather having characteristics of thickness, softness and a fine-break surface.

It is another object of the present invention to provide an improved structure of a synthetic leather by using a piece of all-direction stretchable backing cloth to avoid a poor-break surface.

It is another object of the present invention to provide an improved structure of a synthetic leather by using a piece of all-direction stretchable backing cloth to improve the quality of high-thickness synthetic leather products without the problem that high-thickness synthetic leather products cannot have the characteristic of fine-break surface.

It is a further object of the present invention to provide an improved structure of a synthetic leather by using a piece of all-direction stretchable backing cloth to improve the quality of high-softness synthetic leather products without the problem that high-softness synthetic leather products cannot have the characteristic of fine-break surface.

### BRIEF DESCRIPTION OF THE DRAWINGS

The invention, as well as its many advantages, may be further understood by the following detailed description and drawings in which:

FIG. 1 is a cross-section view of a conventional synthetic leather with a poor-break surface.

FIG. 2 is a cross-section view of a synthetic leather according to the embodiment of the present invention.

FIG. 3 is a cross-section view of a synthetic leather with a fine-break surface according to the embodiment of the present invention.

### DETAILED DESCRIPTION OF THE PREFERRED EMBODIMENT

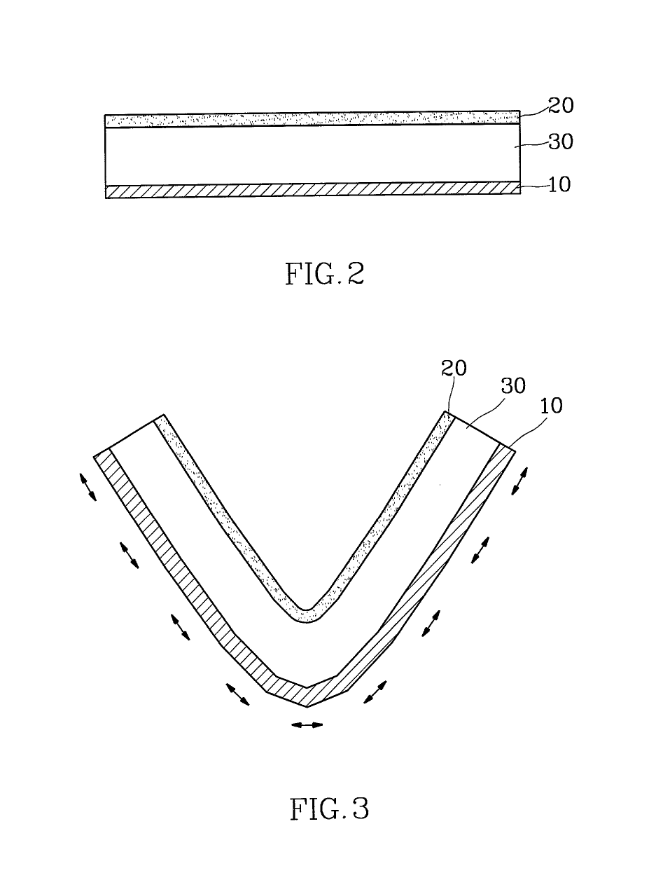

The drawing figures are illustrated a synthetic leather with a three-layer structure as a preferred embodiment of the present invention. Referring now to FIG. 2, a synthetic leather according to this invention includes a surface skin 20, an intermediate layer 30 and a piece of backing cloth 10. According to the object of producing a high-thickness synthetic leather, the total thickness of the surface 20, the intermediate layer 30 and the backing cloth 10 is more than 1.5 mm.

The surface skin 20 is located at one end of the synthetic leather. The surface skin 20 is synthesized by materials, such as polyvinyl chloride (PVC), polyurethane (PU), non-woven cloth, etc., for providing a genuine leather-like touch and appearance. In this embodiment, a PU synthetic leather, P.U. Brazil Leather, is used to be the surface skin 20. The P.U. Brazil Leather itself is a finished synthetic leather with a piece of backing cloth.

The intermediate layer 30 fixed under the surface skin 20 provides the thickness and softness of the synthetic leather of this invention. The materials selection for the intermediate layer 30 is according to the required thickness and softness of applied products. In general, synthetic leather, non-woven cloth, synthetic fiber, synthetic rubber, etc. are possible materials for the intermediate layer 30. In this embodiment, a synthetic rubber with a thickness of about 1.5 mm is used to be the intermediate layer 30.

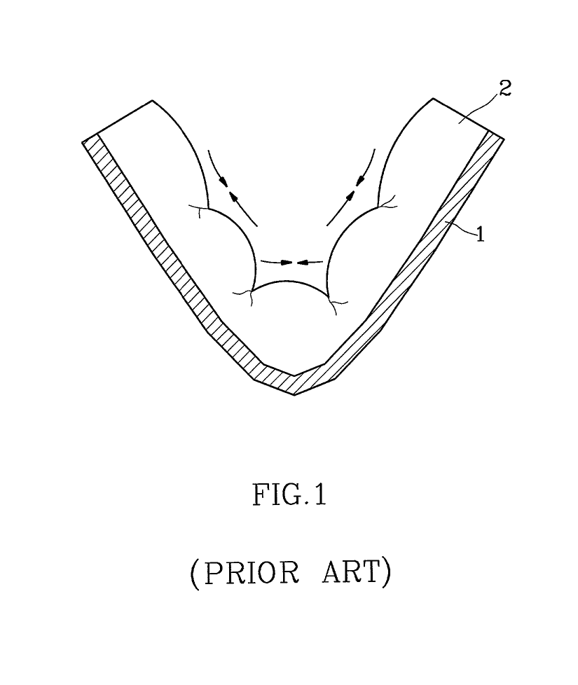

The key of this invention is the backing cloth 10 located at another end of the synthetic leather and fixed under the intermediate layer 30. Conventionally, a piece of backing cloth is set for providing physical strength to the upper structure (including the surface skin and the intermediate layer). However, the inventor of the present invention found that the major reason resulting the disadvantage of synthetic leather surface poor-break is due to the equivalent length of the backing cloth and the upper structure. When the surface of the synthetic leather is bended concave, the backing cloth in a conventional synthetic leather can not be stretched easily because of its poor stretchability. Therefore, the bending force will concentrate to compress in the surface skin of the conventional synthetic leather to form the surface poor-break as shown in FIG. 1. Furthermore, a bended synthetic leather with a higher thickness has a higher degree of surface break roughness due to a stronger compressing force. In the prior art, mostly the backing cloth of a synthetic leather is a piece of non-stretchable cloth which will result surface poor-break at all direction on the synthetic leather surface. Or the backing cloth of a conventional synthetic leather could be a piece of one-direction stretchable cloth which will result surface poor-break at all direction except the only one stretchable direction on the synthetic leather surface.

According to the above description, the present invention uses a piece of cloth with “all-direction stretchability” as the backing cloth of a synthetic leather, which is the key point of this invention. In this embodiment, a two-direction stretchable cloth is selected to be the backing cloth 10. The two-direction stretchable cloth is made for having stretchability at two directions, X and Y directions, which are perpendicular to each other. Because any force applied to the synthetic leather layer can be divided into two components along X and Y directions, the direction along the applied force on the backing cloth is also stretchable. Therefor, the two-direction stretchable cloth is a cloth with “all-direction stretchability”.

Referring to FIG. 3, when the synthetic leather surface is bended concave, the bending force can be applied to the backing cloth 10 easily and “stretches out” the backing cloth 10, because the backing cloth 10 in this invention has a better tensile strength at all directions. Thereby the bending force will not “compress in” the surface skin 20. Therefore, the surface break of the synthetic leather is fine, and the appearance and touch of the synthetic leather are improved efficiently. Even though the thickness and softness of the upper structure (including the surface skin 20 and the intermediate layer 30) is increased, the problem of surface poor-break can be avoided by using a piece of all-direction stretchable cloth for manufacturing high quality products.

As described above, this invention provided an improved structure of synthetic leather by using a piece of all-direction stretchable cloth as the backing cloth. Thereby this invention can avoid the disadvantage of the synthetic leather surface poor-break and provide for manufacturing synthetic leather products concurrently having characteristics of high thickness, high softness and surface fine-break. Although the preferred embodiment provides a three-layer structure, any multilayer structures with the all-direction stretchable backing cloth disclosed by the present invention are covered by this invention, such as a double-layer structure incliding one-layer surface structure and a piece of all-direction stretchable backing cloth, or at least three-layer structure including an at least two-layer upper structure and a piece of all-direction stretchable backing cloth.

It may thus be seen that the objects of the present invention set forth herein, as well as those made apparent from the foregoing description, are efficiently attained. While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A structure of a synthetic leather, comprising:
a piece of backing cloth located at one end of said synthetic leather, wherein said backing cloth having all-direction stretchability;
a surface skin located at another end of said synthetic leather; and
an intermediate layer fixed between said backing cloth and said surface skin.

2. The structure as recited in claim 1, wherein said surface skin has a genuine leather-like appearance.

3. The structure as recited in claim 1, wherein said surface skin is a synthetic leather with a piece of backing cloth.

4. The structure as recited in claim 1, wherein said surface skin, said intermediate layer and said backing cloth have a total thickness of more than 1.5 mm.

5. A structure of a synthetic leather, comprising:
a piece of backing cloth located at one end of said synthetic leather, wherein said backing cloth having all-direction stretchability; and
an upper structure located at another end of said synthetic leather and fixed with said backing cloth, wherein said upper structure having at least one layer structure.

6. The structure as recited in claim 5, wherein said upper structure has a side layer with a genuine leather-like appearance at one surface of said synthetic leather.

7. The structure as recited in claim 5, wherein said upper structure has a side layer at one surface of said synthetic leather, wherein said side layer is a synthetic leather with a piece of backing cloth.

8. The structure as recited in claim 5, wherein said upper structure and said backing cloth have a total thickness of more than 1.5 mm.
